(19) United States
(12) Patent Application Publication
(10) Pub. No.: US 2026/0153370 A1
(43) Pub. Date: Jun. 4, 2026

(54) ACTIVE ULTRASONIC FLOW METER WITH ARTIFICIAL INTELLIGENCE DIAGNOSIS MODULE

(71) Applicant: FM Tech Co., Ltd., Ulsan (KR)

(72) Inventor: Byung Gook HYUN, Ulsan (KR)

(73) Assignee: FM Tech Co., Ltd., Ulsan (KR)

(21) Appl. No.: 18/986,039

(22) Filed: Dec. 18, 2024

(30) Foreign Application Priority Data
Nov. 29, 2024 (KR) 10-2024-0175038

(51) Int. Cl. G01F 1/667

(52) U.S. Cl. CPC G01F 1/667

(57) ABSTRACT

Provided is an active ultrasonic flow meter. The flow meter includes a flow rate measurement sensor for measuring a flow rate in a pipe by an ultrasonic method; a data collection unit for collecting environmental data according to temperatures of the pipe and fluid, a state of the fluid, a state of the pipe, and an external environment of an ultrasonic sensor; a diagnosis module for being learned through deep learning based on a flow rate measurement value of the flow rate measurement sensor and the environmental data, analyzing the current flow rate measurement value input, and outputting the analyzed flow rate measurement value and diagnostic data on normal and abnormal states of the flow rate measurement; and a controller for receiving data output from the diagnosis module, displaying the flow rate measurement value and the diagnostic data, transmitting the value and data to a server, and generating an alarm.

### BACKGROUND OF THE INVENTION

### Field of the Invention

The present invention relates to an ultrasonic flow meter, and more particularly, to an active ultrasonic flow meter having safety and statistical properties by applying a diagnosis module constructed through deep learning of data such as measured temperature, pressure, flow velocity, flow rate, and sensor states by artificial intelligence.

### Background of the Related Art

Generally, as a method of measuring the amount of fluid transferred inside a pipe, there are methods that apply volumetric, turbine, differential pressure, vortex, electromagnetic, and ultrasonic methods to measure volume, and methods such as a Coriolis method or the like that measures mass. Among them, a flow meter that adopts the ultrasonic method is a measurement device that uses ultrasonic waves generated by a sensor and is widely applied currently across the entire field of measuring the amount of fluid.

The ultrasonic flow meter may be installed in a place where the length of straight pipe sections at the front and rear ends is short, or may be installed and applied in a valve or a curved pipe, i.e., the installation locations affected by eddies or the like, which is a type of abnormal flow that causes an error.

In addition, the ultrasonic flow meter may measure the flow rate of all fluids (gases, liquids) and has the advantage of being easily manufactured and installed regardless of the size of a pipe.

A method of measuring a flow rate using the ultrasonic flow meter is divided into a dry method and a wet method according to the installation method of an ultrasonic vibrator, i.e., a transducer.

The wet method is a method of forming a through-hole in a pipe and inserting an ultrasonic transducer in the through-hole, or cutting a pipe and inserting an ultrasonic flow meter in the cut portion, and as shown in FIG. 1, it is a method of arranging ultrasonic transducers 20 and 30 to face each other in a part of the pipe 10, and calculating velocity of fluid by a flow rate calculation means 50 from the difference between the propagation time until ultrasonic waves transmitted from the ultrasonic transducer 20 are received by another ultrasonic transducer 30 and the propagation time until ultrasonic waves transmitted from the ultrasonic transducer 30 are received by the ultrasonic transducer 20, inferring distribution of flow velocity within the pipe 10 from the Reynolds number of the fluid at that time, and obtaining a correction coefficient and calculating the flow rate.

The dry method is a method of coupling an ultrasonic vibrator on the outer wall of a pipe, and a dry ultrasonic flow meter includes a pair of ultrasonic transducers 1 as shown in FIG. 2, and the ultrasonic transducers 1 are coupled to the upstream side and the downstream side of the pipe 2 to be spaced apart from each other.

In the dry ultrasonic flow meter, ultrasonic waves transmitted from the upstream ultrasonic transducer at an incidence angle of θ₁ enter the pipe. At this point, some of the ultrasonic waves are reflected and consumed by the outer wall of the pipe 2, and the other ultrasonic waves are refracted at a refraction angle of θ₂ and transferred to the pipe 2. Thereafter, the ultrasonic waves entering the pipe 2 are refracted at a refraction angle of θ₃ in the fluid inside the pipe to form a path for the ultrasonic waves to be transmitted.

However, when the temperatures of the fluid and the pipe change, the refractive indices of the fluid and the pipe change, and accordingly, the propagation path of the ultrasonic waves changes as the refraction angle changes as is shown by the virtual line i. Of course, since the ultrasonic waves transmitted from the ultrasonic transducer are propagated while having a predetermined orientation angle, even when the propagation path of the ultrasonic waves changes slightly, the ultrasonic waves are received by the ultrasonic transducer on the opposite side. However, when the ultrasonic waves are received in a non-optimal state (i.e., transmitted by the orientation angle), as the wavefront of the arriving ultrasonic beam does not match the ultrasonic transmission surface of the ultrasonic transducer on the opposite side (downstream side), a phase difference of wavefront occurs, and accordingly, an error occurs in the delay time.

Here, the delay time refers to the difference in time between the time required for an ultrasonic wave transmitted from an upstream ultrasonic transducer to be received by a downstream ultrasonic transducer and the time required for an ultrasonic wave transmitted from a downstream ultrasonic transducer to be received by an upstream ultrasonic transducer.

In the case of the dry ultrasonic flow meter, there is a problem in that the measured flow rate is inaccurate since there is no way to efficiently compensate for the error in the delay time according to temperature change.

Of course, in order to correct the error in the delay time according to temperature change, Korean Patent Registration No. 10-1022407 (dry ultrasonic flow meter) has proposed a method of measuring a required first time that is required from the time point when an ultrasonic wave is transmitted from an upstream ultrasonic transducer in the direction of flow of the fluid among a pair of ultrasonic transducers to the time point when the ultrasonic wave passes through the pipe and is received by a downstream ultrasonic transducer, and a second required time that is required from the time point when an ultrasonic wave is transmitted from a downstream ultrasonic transducer to the time point when the ultrasonic wave passes through the same path as that of the ultrasonic wave transmitted the from upstream ultrasonic transducer and is received by an upstream ultrasonic transducer, measuring a third required time that is required from the time point when the ultrasonic wave is transmitted from an ultrasonic sensor until the ultrasonic wave passes through an auxiliary housing coupled to the outer wall of the pipe and reaches the outer wall of the pipe, a fourth required time that is required for the ultrasonic wave that has reached the outer wall of the pipe to pass through the pipe, and a fifth required time that is required from the time point when the ultrasonic wave is transmitted from the ultrasonic sensor until the ultrasonic wave passes through the pipe, enters the fluid, is reflected by the inner surface of the pipe, and is received by the ultrasonic sensor, and accurately calculating the flow rate of the fluid using the difference between the measured first required time and second required time, and the third, fourth and fifth required times.

However, these general wet and dry ultrasonic flow meters manage data using a lot of measurement data such as the fluid states (flow velocity distribution, temperature distribution, fluid uniformity, noise, etc.), pipe states (expansion, ovality, change in cross-sectional area, etc.), external environments of the ultrasonic sensor (temperature, humidity, vibration, etc.), and installation factors (factors according to straight pipe, illuminance inside the pipe, the user's installation conditions, etc.), as well as temperature change, for the sake of statistical approaches or maintenance. However, it is difficult to predict in advance these many factors that affect measurement, and it is also very difficult to analyze the measurement data one by one and make a plan for statistical approach and maintenance.

That is, it is very difficult for a manager to analyze current measurement data and past measurement data one by one and make a plan for fault diagnosis and maintenance of many ultrasonic flow meters on the basis of analyzed results. In addition, as the analysis results may vary according to the skill level of a manager, an appropriate plan for fault diagnosis and maintenance may not be established based on data having stability and statistical properties.

In addition, a plurality of ultrasonic flow meters is installed in a pipe recently, and measured data thereof is received through a network and managed by a server. However, such a network has a problem of being exposed to malicious code when it is vulnerable to security breaches.

For example, when an ultrasonic flow meter is installed in an industrial core facility, such as a thermal power plant, nuclear power plant, semiconductor manufacturing factory, or the like, and is connected to a network, there is a problem in that when the ultrasonic flow meter is exposed to malicious code and an error occurs in the flow rate measurement value, it may cause significant damage to the industrial facility.

### PRIOR ART DOCUMENTS

1. Korean patent registration No. 10-0311555
   (Ultrasonic Flow Meter)
2. Korean patent registration No. 10-1022407
   (Dry Ultrasonic Flow Meter)

### SUMMARY OF THE INVENTION

Therefore, the present invention has been made in view of the above problems, and it is an object of the present invention to provide an active ultrasonic flow meter, which may facilitate establishment of a plan for statistical approach and maintenance using data having stability and statistical properties by constructing a diagnosis module through deep learning of data measured by an ultrasonic flow meter using artificial intelligence, and enhance security by infiltration of malicious code that occurs when a blocking plurality of ultrasonic flow meters transmits measured data through a network.

To accomplish the above object, according to one aspect of the present invention, there is provided an active ultrasonic flow meter comprising: a flow rate measurement sensor for measuring a flow rate in a pipe by an ultrasonic method; a data collection unit for collecting environmental data according to temperatures of the pipe and fluid, a state of the fluid (flow velocity distribution, temperature distribution, fluid y uniformity, noise), a state of the pipe (expansion, ovality, change in cross-sectional area), and external environments of an ultrasonic sensor (temperature, humidity, vibration); a diagnosis module for being learned through deep learning based on a flow rate measurement value of the flow rate measurement sensor and the environmental data collected by the data collection unit, analyzing the current flow rate measurement value input from the flow rate measurement sensor by reflecting the current environmental data collected from the data collection unit by learned artificial intelligence, and outputting the analyzed flow rate measurement value and diagnostic data on normal and abnormal states of the flow rate measurement; and a controller for receiving data output from the diagnosis module, displaying the flow rate measurement value and the diagnostic data through a display unit, transmitting the value and data to a server through a communication unit, and generating an alarm through an alarm unit.

In addition, the active ultrasonic flow meter further comprises: a maintenance module for being is learned through deep learning using information on a characteristic of change in the flow rate measurement value of the flow rate measurement sensor, a type of the ultrasonic flow meter, the manufacturer and model of the ultrasonic flow meter, an output value and its error range of each model, and a change of the output value according to a degree of aging, and determining generation of an alarm for maintenance by reflecting a variable value and a time for an installation period on flow rate data input from the flow rate measurement sensor by learned artificial intelligence; an input unit for inputting variable values of a manufacturer, a model number, and an installation date of the flow rate measurement sensor into the maintenance module; and a counter for calculating and providing, when the variable value is input into the maintenance module, a time for the installation period of the flow rate measurement sensor to the analysis module, wherein the communication unit receives the alarm for maintenance output from the maintenance module through the controller and outputs the alarm through a network.

In addition, the communication unit transmits data to the server through an IoT network, and the active ultrasonic flow meter is further provided with a malicious code detection unit for detecting malicious code in the IoT network, wherein the malicious code detection unit is configured of: a plurality of virtual ultrasonic flow meters operated by a virtualization operation server; a detection module equipped with a cross compiler that supports a plurality of architectures and operating systems, and connected to the virtual ultrasonic flow meters and actual ultrasonic flow meters to be included in a network, to confirm states of the connected virtual ultrasonic flow meters and actual ultrasonic flow meters, allocate and manage internal memory for the virtual ultrasonic flow meters and the actual ultrasonic flow meters, block malicious code by a blocking process when the malicious code is detected by the code analysis unit for the actual ultrasonic flow meters in real time, dump malicious code attacking the virtual ultrasonic flow meters as binary code when the malicious code is detected by the code analysis unit, transmit the dumped malicious code data to the server, and transmit an IP address of the ultrasonic flow meter in which the malicious code is detected; and a server that communicates with the detection module on the basis of token to receive the malicious code transmitted from the detection module, analyze the malicious code through deep learning, and store the malicious code to update a database.

In addition, when attenuation of an ultrasonic signal exceeds a set value, the diagnosis module switches from a time-of-flight method to a reflector tracking ultrasonic signal detection mode and receives measurement data from the flow rate measurement sensor.

### BRIEF DESCRIPTION OF THE DRAWINGS

FIG. 1 is a view showing the structure of a wet ultrasonic flow meter according to the prior art.

FIG. 2 is a view showing the structure of a dry ultrasonic flow meter according to the prior art.

FIG. 3 is a view for explaining a reflector tracking ultrasonic signal detection mode.

FIG. 4 is a block diagram showing an active ultrasonic flow meter according to the present invention.

FIG. 5 is a view showing the appearance of a pipe in which an ultrasonic flow meter of the present invention is installed.

FIG. 6 is a detailed block diagram showing a malicious code detection unit.

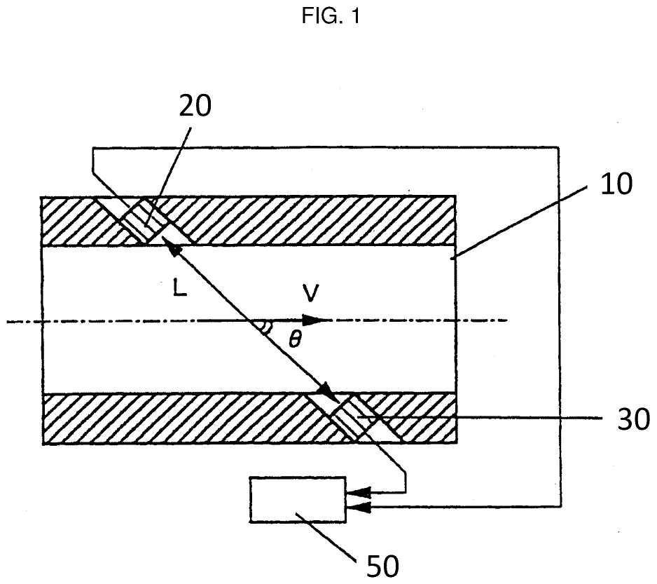

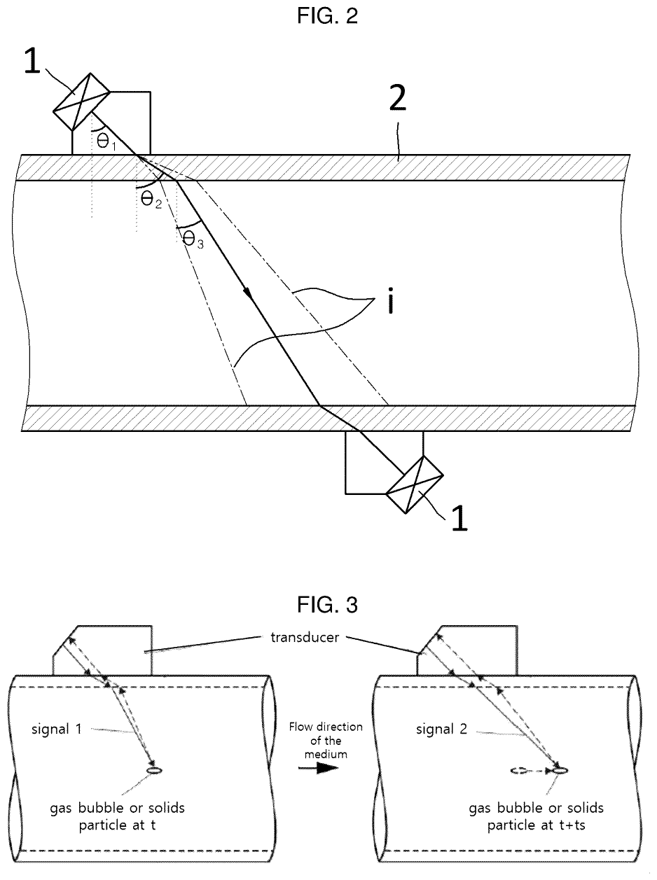

### DETAILED DESCRIPTION OF THE PREFERRED EMBODIMENT

Hereinafter, embodiments of the present invention will be described in detail with reference to the accompanying drawings.

However, the embodiments of the present invention exemplified below may be modified into various other forms, and the scope of the present invention is not limited to the embodiments described below.

The embodiments of the present invention are provided to more fully describe the present invention to those skilled in the art.

In actually operating an ultrasonic flow meter, external factors greatly contribute to measurement. Therefore, when the ultrasonic flow meter is installed and applied on site, a computational fluid flow analysis (CFD) simulation is performed based on data that has verified the basic design through three-dimensional modeling by reviewing the application scope of each sensor for each material and reflecting the characteristics according to the chemical properties of applied fluid, a database is constructed by reflecting theoretical modeling of external factors, and a basic diagnosis base is established by securing basic data actually applied in an installation site.

Here, the external factors include the fluid states (flow velocity distribution, temperature distribution, fluid uniformity, noise, etc.), pipe states (expansion, ovality, change in cross-sectional area, etc.), external environments of (temperature, humidity, vibration, etc.), the ultrasonic sensor and installation factors (factors related to straight pipe section, illuminance inside the pipe, user's installation, etc.).

The basic measurement of the ultrasonic flow meter uses a time-of-flight method that measures the time difference of an ultrasonic signal, and when the proportion of inflow of solid particles or gas bubbles increases in the fluid, the attenuation of the ultrasonic signal is too high for complete propagation of the fluid, and therefore, measurement using the time-of-flight method is not allowed any longer.

At this point, when attenuation of the ultrasonic signal increases to be higher than a set value, a diagnosis module 104 of artificial intelligence switches the measurement method from the time-of-flight method to the reflector tracking ultrasonic signal detection mode (RTM) and receives measurement data from a flow rate measurement sensor 101.

The RTM is a method of measuring an ultrasonic signal reflected by a reflector using a sensor. Describing with reference to FIG. 3, the initial fire time t_{P1} of an ultrasonic signal transmitted from an ultrasonic sensor and the time t₁ of a radio signal S₁ reflected by a reflector, and the fire time t_{P2} of a next ultrasonic signal and the time t₂ of the reflected radio signal S₂ are measured, and the measurement is made by the difference in the passage time of these two consecutive ultrasonic signals.

The reflector is proportional to the distance through which two consecutive ultrasonic signals pass, and also varies according to the average flow velocity of fluid.

This is expressed by equation 1.

$$\begin{matrix}v = {k}_{Rc} \cdot {k}_{a} \cdot \frac{Δ {t}_{s}}{2 \cdot Δ {t}_{p}} \\ Δ {t}_{s} = {t}_{s 2} - {t}_{s 1} \\ Δ {t}_{P} = {t}_{P 2} - {t}_{P 1} = \frac{1}{{t}_{r}}\end{matrix} \qquad [ Equation 1 ]$$

Here, definition of each variable is as shown below.
v: Average flow velocity of fluid
k_{Rc}: Fluid machinery correction factor
kₐ: Acoustic correction factor
Δtₛ: Time difference measured between two signals (S₁, S₂)
Δtₚ: Time difference between two consecutive fire pulses

$${k}_{a} = \frac{{c}_{{θ}_{0}}}{sin {θ}_{0}} = \frac{{c}_{{θ}_{1}}}{sin {θ}_{1}} = \frac{{c}_{{θ}_{2}}}{sin {θ}_{2}}$$

The acoustic correction factors follow the Snell's law of refraction, and here, θ₀, θ₁, and θ₂ are incidence angles of media, and c_{θ}_{₀}, c_{θ}_{₁}, c_{θ}_{₂} and are speed of sound of the media.

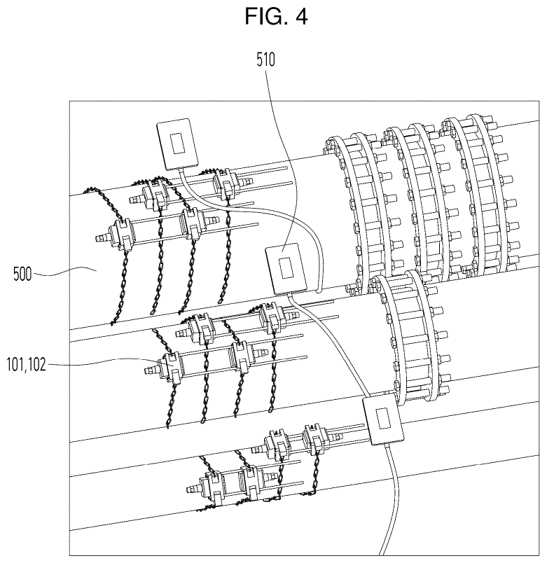

As shown in FIG. 4, an active ultrasonic flow meter 100 according to the present invention is largely configured of a flow rate measurement sensor 101, a data collection unit 102, a preprocessing unit 103, a diagnosis module 104, a controller 106, a communication unit 110, a display unit 111, and an alarm unit 112.

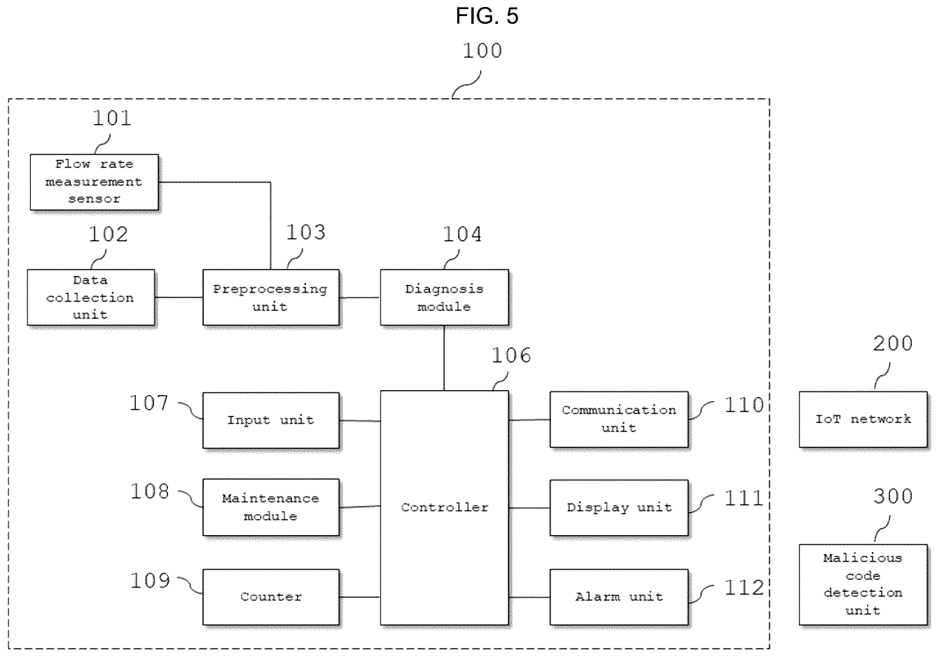

In addition, as shown in FIG. 5, a flow rate measurement sensor 101 and a data collection unit 102 are fixedly installed on the outer side surface of a pipe 500, and other structures have a structure of being accommodated inside a control box 510 and installed in each of a plurality of pipes 500.

The flow rate measurement sensor 101 measures the flow rate in the pipe 500 in a wet or dry method as shown in the prior art.

The data collection unit 102 collects the temperature of the pipe 500 and the temperature of the fluid inside the pipe 500, and environmental data such as the fluid states (flow velocity distribution, temperature distribution, fluid uniformity, noise, etc.), pipe states (expansion, ovality, change in cross-sectional area, etc.), external environments of the ultrasonic sensor (temperature, humidity, vibration, etc.), and the like, which are external factors.

To this end, the data collection unit 102 may be configured of various sensors, and for example, it may be configured of a temperature sensor, a humidity sensor, a flow velocity sensor, a microphone, a volume sensor, a vibration sensor, and the like.

The preprocessing unit 103 processes the flow rate measurement value and environmental data received from the flow rate measurement sensor 101 and the data collection unit 102 into data to be used for measuring the flow rate and determining the flow meter state.

The diagnosis module 104 is learned through deep learning based on the flow rate measurement value of the flow rate measurement sensor 101 and the environmental data collected by the data collection unit 102, analyzes the current flow rate measurement value input from the flow rate measurement sensor 101 by reflecting the current environmental data collected from the data collection unit 102 by the learned artificial intelligence, and outputs the analyzed flow rate measurement value and diagnostic data on the normal and abnormal states of the flow rate measurement.

That is, since the diagnosis module 104 is deeply learned by reflecting variables according to the environmental data to the actual flow rate measurement value, an abnormal situation of flow rate measurement may be diagnosed due to a change in the environmental data although a normal flow rate measurement value is input.

As various environmental data are given as variables, and data on the difference between the actual flow rate according to the change in each environmental data and the flow rate measurement value are given and learned as learning data, the diagnosis module 104 may output diagnostic data on the normal and abnormal states of the flow rate measurement.

In addition, as a cross compiler is mounted on the diagnosis module 104 to support a plurality of architectures and operating systems, it is not affected even when the architecture and operating system of the flow rate measurement sensors 101 are different.

That is, when the degree of aging of the flow rate measurement sensor 101 is different, it may be difficult to confirm the state of the flow rate measurement sensor 101 since the architecture and operating system may be different. However, as a cross compiler is mounted on the diagnosis module 104 to support various architectures and operating systems, it is not affected by the degree of aging of the flow rate measurement sensor 101.

The controller 106 is applied with the flow rate measurement value and diagnostic data output from the diagnosis module 104, displays the value and data through the display unit 111, transmits the value and data to a server 400 at a remote site through the communication unit 110 and an IoT network 200, and generates an alarm through an alarm unit 112 in the case of data about an abnormal state of the flow rate measurement.

Meanwhile, the active ultrasonic flow meter 100 of the present invention is further provided with a maintenance module 108 for generating a maintenance alarm according to aging of the flow rate measurement sensor 101. The maintenance module 108 is constructed deep through learning by artificial intelligence to use, as an input value, information on various ultrasonic flow meters, such as the characteristic of change in the flow rate measurement value of the flow rate measurement sensor 101, characteristic values of various ultrasonic flow meters, i.e., types of the ultrasonic flow meters, manufacturers of ultrasonic flow meters, output values and their error range of each model, changes in the output value according to the degree of aging, and the like, and use the output value as the output of an alarm signal for maintenance.

The input unit 107 is for a manager to input variables such as manufacturer, model number, and the installation date of the flow rate measurement sensor 101. The input unit 107 may be provided in the ultrasonic flow meter 100 or may be a connection terminal to which a mobile device of the manager may be connected.

That is, the input unit 107 may be connected to a portable device such as a smart phone, a tablet PC, or the like possessed by the manager by wire through a data cable, or may be connected to the input unit 107 through near field communication such as Wi-Fi, Bluetooth, or the like. To this end, the input unit 107 may be a physical connector or a near field wireless transmission/reception device.

When information on various variables of the ultrasonic flow meter, i.e., the flow rate measurement sensor 101, is input into the maintenance module 108 through the input unit 107, a counter 109 calculates the time and provides the calculated value to the maintenance module 108.

According thereto, when a flow rate measurement value is input from the flow rate measurement sensor 101 to the maintenance module 108, the flow rate measurement value is analyzed based on the result of deep learning. When the flow rate measurement value input from the flow rate measurement sensor 101 is within a set range, for example, within a range of +5% of the maximum flow rate inside the pipe 500, a maintenance alarm signal is not output. On the other hand, when the flow rate measurement value is outside the range of +5%, a maintenance alarm signal is output according to the analyzed result by reflecting the variables set by the input unit 107 and variables such as the degree of aging according to the time elapsed from the installation date calculated by the counter 109.

Meanwhile, as the ultrasonic flow meter 100 is [0063] integrated with the IoT network 200 that forms a network together with a plurality of ultrasonic flow meters, the ultrasonic flow meters 100 may communicate with each other, and this allows the flow rate measurement values and environmental data to be exchanged with each other to be used as re-learning data of the diagnosis module 104.

However, since the IoT network 200 is open to wired and wireless IP networks, it is very vulnerable to security.

Therefore, the malicious code detection unit 300 may detect malicious code in the IoT network 200.

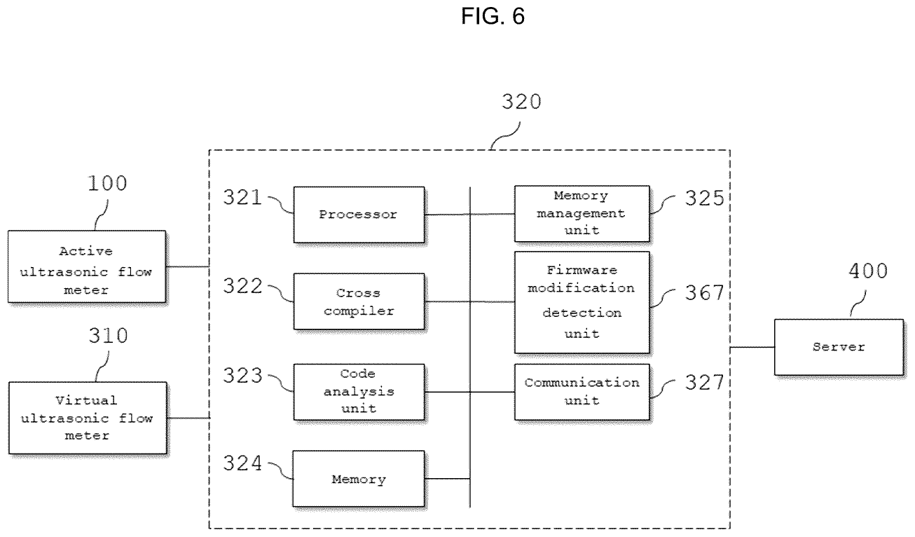

To this end, the malicious code detection unit 300 is largely configured of a plurality of ultrasonic flow meters 100, a plurality of virtual ultrasonic flow meters 310, a detection module 320, and a server 400, as shown in FIG. 6.

The virtual ultrasonic flow meters 310 implement a virtual environment by software or the like, and also have a virtualization operation server for operating these virtual ultrasonic flow meters 310.

The actual ultrasonic flow meters 100 are configured as an IoT network 200 in a wired or wireless manner.

The detection module 320 is included in the IoT network 200 through connection of the virtual ultrasonic flow meters 310 and the actual ultrasonic flow meters 100, and confirms the states of the ultrasonic flow meters 100, such as power, boot, service operation, and the like, and detects and blocks malicious code.

In addition, the detection module 320 detects malicious code attacking the virtual ultrasonic flow meters 310 dumps the detected malicious code as binary code, and blocks the malicious code. When the virtual ultrasonic flow meters 310 malfunction despite the blocking, the detection module 320 transmits malfunction data to the server 400 through the communication unit 327 together with the dumped malicious code, and the server 400 stores the malicious code as binary code and also stores the malfunction data in a database.

This is to allow the server 400 to collect malicious code dropped and deleted soon after being executed, and to improve detection performance of a code analysis unit 323 of the detection module 320 by performing deep learning based on the collected malicious code and malfunction data.

That is, malicious code attacking the actual ultrasonic flow meters 100 is immediately blocked by duplicating the virtual ultrasonic flow meters 310 and the actual ultrasonic flow meters 100, and new malicious code attacking the actual ultrasonic flow meters 100 may be blocked more efficiently as the malicious code attacking the virtual ultrasonic flow meters 310 and the malfunction data are collected and the server 400 analyzes the malicious code through deep learning and updates the code analysis unit 323 of the detection module 320.

The communication unit 327 is configured of a communication module for communication with the virtual ultrasonic flow meters 310 and the actual ultrasonic flow meters 100, and a communication module for wired or wireless communication with the server 400. In the case of communication, it may operate in a wireless communication method such as Wi-Fi, Bluetooth, Near Field Communication (NFC), Zigbee, RF, or the like.

The communication with the server 400 may include wired Internet networks or the like, as well as wireless communication such as Wi-Fi, Bluetooth, Near Field Communication (NFC), Zigbee, RF, mobile communication, or the like.

The detection module 320 may have a structure installed to 1:1 match to each of the virtual ultrasonic flow meters 310 and actual ultrasonic flow meters 100, or a plurality of virtual ultrasonic flow meters 310 and actual ultrasonic flow meters 100 are connected to one detection module 320.

In addition, it is preferable for the virtual ultrasonic flow meters 310 to be implemented to be the same as the actual ultrasonic flow meters 100, and implemented as virtual machines.

That is, as the virtualization operation server creates a dynamic virtual machine based on the CPU and OS information of the actual ultrasonic flow meters 100, the virtual ultrasonic flow meters 310 is constructed as a dynamic sandbox in which influence related to operation can be confirmed.

The code analysis unit 323 is constructed in the detection module 320 to detect malicious code, and the code analysis unit 323 automatically analyzes and detects malicious code by an analysis module constructed in deep learning. To this end, the code analysis unit 323 is constructed by deep learning signatures extracted from various normal code directories and malicious code stored in the database of the server 400 and generating an automatic ruleset.

In addition, the server 400 may automatically analyze the malicious code stored in the database using a deep learning algorithm to extract IoC or the like and then implement process automation of active responses such as automatic tracking of distribution sites and preemptive strikes.

In addition, the server 400 may automatically generate a Yara Ruleset by performing deep learning on the extracted IoC so that it may be applied to the IDS/IPS/firewall or the like.

In addition, as data on malfunction of the virtual ultrasonic flow meters 310 according to malicious code is also analyzed through deep learning, it is possible to prepare countermeasures according to the type of malfunction that has occurred or may occur in the virtual ultrasonic flow meters 310 due to the malicious code.

That is, owing to these countermeasures, the code analysis unit 323 of the detection module 320 may improve the ability of detecting new malicious code.

With a learning model for the deep learning, it is possible to learn signature information through various learning algorithms such as neural network, pseudo-tree decision, random forest, support vector machine, and the like, and in the present invention, the learning model of the code analysis unit 323 is constructed using a neural network.

The neural network is an algorithm implemented by imitating the human brain, and is configured of an input layer, a hidden layer, and an output layer, and is configured of nodes connected between the input layer and the hidden layer, and between the hidden layer and the output layer.

The input layer is a layer that receives and stores extracted signature information, and is configured of as many pieces of information as the information configuring the input signature, the output layer is configured of as many pieces of information as the information on the finally derived result, and the hidden layer is an intermediate layer that reaches the output layer from the input layer.

Accordingly, as the signature information extracted for learning is input into the input layer, and weights of the nodes are changed through learning, the learning model of the code analysis unit 323 is constructed.

The code analysis unit 323 constructed by the neural network algorithm extracts a signature from the code and process input through the communication unit 327 and detects malicious code by classifying the extracted signature using the constructed learning model.

When malicious code is detected in the actual ultrasonic flow meters 100 as described above, a processor 321 dumps the malicious code as binary code and blocks it immediately not to be stored in the actual ultrasonic flow meters 100 and generates a detection alarm. In addition, when malicious code is detected in the virtual ultrasonic flow meters 310, the processor 321 dumps the malicious code as binary code and blocks it immediately not to be stored in the virtual ultrasonic flow meters 310 and the detection module 320, and transmits it to the server 400 through the communication unit 327.

Of course, even when the virtual ultrasonic flow meters 310 malfunction despite the blocking, malfunction data thereof is transmitted to the server 400.

In addition, when files or folders are created/changed in several directories, malicious code is detected by detecting the change through a hash algorithm, and malicious code attacking the virtual ultrasonic flow meters 310 and the actual ultrasonic flow meters 100 is detected by detecting arbitrary creation or change of a manager account or a user account by monitoring directories such as etc/shadow and etc/passwd.

In addition, the processor 321 automatically re-executes the process when the process being executed is forcibly terminated due to the malicious code, and performs secure coding such as encryption or obfuscation on some of the code in preparation for modification or attacks targeting the detection module 320.

Meanwhile, as the detection module 320 is equipped with a cross compiler 322 to support a plurality of architectures and operating systems, it is not affected even when the architectures and operating systems of the actual ultrasonic flow meters 100 are different from each other.

That is, when the degrees of aging of the actual ultrasonic flow meters 100 are different, the architectures and operating systems may be different from each other, and it is difficult to confirm the states of the actual ultrasonic flow meters 100. However, as the detection module 320 is equipped with the cross compiler 322 to support various architectures and operating systems, it is not affected by the degree of aging of the actual ultrasonic flow meters 100.

The cross compiler 322 has various and stable cross compilers such as ARM64, ARMv6, ARMv7, MIPS, MIPS64, NetBSD, and the like, and also has various supported operating systems such as iOS, Android, Windows Embedded, Debian, Arch, CentOS, Redhat, Unix, and the like.

In addition, it has various supported architectures such as ARM series, MIPS series, and Intel architecture.

As the cross compiler 322 written using Rust, which is one of system development languages, extracts necessary libraries and packages from the firmware of various ultrasonic flow meters 100 and compiles based on the libraries and packages, it is not affected by hardware resources such as the memory, processes, and the like of the ultrasonic flow meters 100.

To this end, the detection module 320 directly processes usage of the system and development language management of the memory of the ultrasonic flow meters 100, and the processor 321 controls a memory management unit 325 to allocate the system development language area and the memory management area of each of the connected actual ultrasonic flow meters 100.

According thereto, even when the actual ultrasonic flow meters 100 have insufficient memory, outdated hardware and processes, and the like, the IoT network 200 may operate stably as the detection module 320 performs management.

The detection module 320 detects firmware modification of the actual ultrasonic flow meters 100. To this end, the firmware modification detection unit 326 hashes all system directories from the firmware of each of the actual ultrasonic flow meters 100 using a hash algorithm and extracts and stores the hash value in the memory 324. Thereafter, the hash values are extracted at regular intervals to compare the currently extracted hash value with the previous hash value, and when the hash value is changed, it may detect that the firmware has been modified and generates an alarm.

Alternatively, the firmware modification detection unit 326 may be provided as a security chip based on a SoC (System-On-Chip), and at this point, apart from the firmware, when a change occurs in the memory chip of the actual ultrasonic flow meters 100 in which the firmware is installed, it may detect the change as firmware modification and generate an alarm.

Of course, since it would be natural for the detection module 320 or the server 400 to execute a process that blocks malicious code and generates an alarm, description thereof is omitted.

In addition, since the code analysis unit 323 has a structure of detecting malicious code and immediately dumping it as binary code in an environment where the virtual ultrasonic flow meters 310 are connected to the detection module 320, it may be configured to be simpler than the environment of the actual ultrasonic flow meters 100.

As the detection module 320 and the server 400 communicate on the basis of token, lightweight of the code is implemented by transmitting only specific necessary data, and through this, performance degradation of the actual ultrasonic flow meters 100 is prevented.

The detection module 320 and the server 400 may be constructed as a separate on-premise server when they are configured as a separated network, otherwise, they may be managed by Terraform in a cloud-based service such as Amazon Web Service (AWS), Microsoft's Azure, Google Cloud Platform (GCP), or the like.

The server 400 is configured of a backend server and a frontend server. The backend server is configured of a license server, a policy server, an authentication server, a middleware server, and a cache server, and a database is configured to be separated for each part. The backend server is developed in Rust in the same manner as the detection module 320, and the frontend server is developed in React.

When the initial virtual ultrasonic flow meters 310 and the actual ultrasonic flow meters 100 are connected to the detection module 320 and request the backend server for device registration, a policy is created, and when the manager completes the registration after setting policy rules of detection, blocking, and the like, the backend server communicates with the detection module 320 every predetermined time unit (e.g., 5 minutes) and continuously confirms the license and policy, such as the states of the virtual ultrasonic flow meters 310 and the actual ultrasonic flow meters 100.

As all of these communications are performed on the basis of token as mentioned above, the middleware server and the cache server process unnecessary communication data, and as the virtual ultrasonic flow meters 310 and the actual ultrasonic flow meters 100 are managed on the basis of the policy, data of only a maximum of KB is generated at regular intervals for the virtual ultrasonic flow meters 310 and the actual ultrasonic flow meters 100, and the amount of traffic data and the data stored in the database may be reduced significantly.

As a real-time protocol monitoring system dedicated to IoT, such as mqtt, modbus/TCP, s7comm plus, OPCUA, and the like, is constructed in the backend server, malicious code may also be detected on the basis of network traffic in a 3-tiered detection of process, directory, and network.

In addition, the frontend server includes a list of processes treated as an exception of detection when the detection module 320 begins, and sets in real time a list of detection processes, directory paths, a list of new abnormal and malicious processes, and the like set by the user.

This means that monitoring, collection, and analysis activities may be performed in real time.

In addition, the results detected by the detection module 320 and the results detected by the backend server may be transmitted to the terminal of the manager or client by the server 400, and the terminal of the manager or client may be various terminals such as a desktop computer, a tablet computer, a smartphone, or the like for monitoring, and information on the detection results may be transmitted through a wired or wireless Internet network, a mobile communication network, or the like.

According to the present invention configured as described above, as data having stability and statistical properties is provided to a manager by constructing a diagnosis module through deep learning of data measured by an ultrasonic flow meter using artificial intelligence, there is an advantage of facilitating establishment of a plan for statistical approach and maintenance.

In addition, there is an advantage of enhancing security by blocking infiltration of malicious code that occurs when a plurality of ultrasonic flow meters transmits measured data through a network.

### DESCRIPTION OF SYMBOLS

| | |
|---|---|
| 100: Active ultrasonic flow meter | |
| 101: Flow rate measurement sensor | |
| 102: Data collection unit | 103: Preprocessing unit |
| 104: Diagnosis module | 106: Controller |
| 107: Input unit | 108: Maintenance module |
| 109: Counter | 110: Communication unit |
| 111: Display unit | 112: Alarm unit |
| 200: IoT network | 300: Malicious code detection unit |
| 310: Virtual ultrasonic flow meter | |
| 320: Detection module | |
| 321: Processor | 322: Cross compiler |
| 323: Code analysis unit | 324: Memory |
| 325: Memory management unit | 326: Firmware modification |
| | detection unit |
| 327: Communication unit | 400: Server |
| 500: Pipe | 510: Control box |

What is claimed is:

1. An active ultrasonic flow meter comprising:
a flow rate measurement sensor for measuring a flow rate in a pipe by an ultrasonic method;
a data collection unit for collecting environmental data according to temperatures of the pipe and fluid, a state of the fluid, a state of the pipe, and external environments of an ultrasonic sensor;
a diagnosis module for being learned through deep learning based on a flow rate measurement value of the flow rate measurement sensor and the environmental data collected by the data collection unit, analyzing the current flow rate measurement value input from the flow rate measurement sensor by reflecting the current environmental data collected from the data collection unit by learned artificial intelligence, and outputting the analyzed flow rate measurement value and diagnostic data on normal and abnormal states of the flow rate measurement; and
a controller for receiving data output from the diagnosis module, displaying the flow rate measurement value and the diagnostic data through a display unit, transmitting the value and data to a server through a communication unit, and generating an alarm through an alarm unit.

2. The active ultrasonic flow meter according to claim 1, further comprising:
a maintenance module for being is learned through deep learning using information on a characteristic of change in the flow rate measurement value of the flow rate measurement sensor, a type of the ultrasonic flow meter, the manufacturer and model of the ultrasonic flow meter, an output value and its error range of each model, and a change of the output value according to a degree of aging, and determining generation of an alarm for maintenance by reflecting a variable value and a time for an installation period on flow rate data input from the flow rate measurement sensor by learned artificial intelligence;
an input unit for inputting variable values of a manufacturer, a model number, and an installation date of the flow rate measurement sensor into the maintenance module; and
a counter for calculating and providing, when the variable value is input into the maintenance module, a time for the installation period of the flow rate measurement sensor to the analysis module, wherein
the communication unit receives the alarm for maintenance output from the maintenance module through the controller and outputs the alarm through a network.

3. The active ultrasonic flow meter according to claim 1, wherein
the communication unit transmits data to the server through an IoT network, and the active ultrasonic flow meter is further provided with a malicious code detection unit for detecting malicious code in the IoT network, wherein
the malicious code detection unit is configured of:
a plurality of virtual ultrasonic flow meters operated by a virtualization operation server;
a detection module equipped with a cross compiler that supports a plurality of architectures and operating systems, and connected to the virtual ultrasonic flow meters and actual ultrasonic flow meters to be included in a network, to confirm states of the connected virtual ultrasonic flow meters and actual ultrasonic flow meters, allocate and manage internal memory for the virtual ultrasonic flow meters and the actual ultrasonic flow meters, block malicious code by a blocking process when the malicious code is detected by the code analysis unit for the actual ultrasonic flow meters in real time, dump malicious code attacking the virtual ultrasonic flow meters as binary code when the malicious code is detected by the code analysis unit, transmit the dumped malicious code data to the server, and transmit an IP address of the ultrasonic flow meter in which the malicious code is detected; and
a server that communicates with the detection module on the basis of token to receive the malicious code transmitted from the detection module, analyze the malicious code through deep learning, and store the malicious code to update a database.

4. The active ultrasonic flow meter according to claim 1, wherein when attenuation of an ultrasonic signal exceeds a set value, the diagnosis module switches from a time-of-flight method to a reflector tracking ultrasonic signal detection mode and receives measurement data from the flow rate measurement sensor.
